(19) United States
(12) Patent Application Publication
(10) Pub. No.: US 2018/0016091 A1
(43) Pub. Date: Jan. 18, 2018

(54) Personalizable Single-Use Brewing Pod

(71) Applicant: Jerry Paige, Vernon Hills, IL (US)

(72) Inventor: Jerry Paige, Vernon Hills, IL (US)

(21) Appl. No.: 15/210,303

(22) Filed: Jul. 14, 2016

(51) Int. Cl. B65D 85/804; A47J 31/06; B65D 43/22; B65D 65/46

(52) U.S. Cl. CPC B65D 85/8043; B65D 65/466; A47J 31/0642; B65D 43/22

(57) ABSTRACT

A personalizable single-use brewing pod for user selected brewing of hot beverages includes a cup that has an annular wall that extends upwardly from a bottom to define an open top. A filter that is positioned in the cup defines a brewing chamber that is configured for addition of contents, including extractable solids such as coffee grounds, and dissolvable solids, such as chocolate. A lid that is complementary to the open top is configured to sealably couple to the cup to preserve the contents in a fresh state. The cup with the lid coupled thereto is positionable in a brewing machine. An insert that is positioned in the lid is configured to be pierced by the spray nozzle of the brewing machine. The bottom is configured to be pierced by a discharge nozzle of the brewing machine, such that a hot drink is provided to a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

(1) Field of the Invention.

(2) Description of Related Art including information disclosed under 37 CFR 1.97 and 1.98.

The disclosure and prior art relates to brewing pods and more particularly pertains to a new brewing pod for user selected brewing of hot beverages.

### BRIEF SUMMARY OF THE INVENTION

An embodiment of the disclosure meets the needs presented above by generally comprising a cup that has an annular wall that extends upwardly from a bottom to define an open top. A filter that is positioned in the cup defines a brewing chamber that is configured for addition of contents, including extractable solids such as coffee grounds, and dissolvable solids, such as chocolate. A lid that is complementary to the open top is configured to sealably couple to the cup to preserve the contents in a fresh state. The cup with the lid coupled thereto is positionable in a brewing machine. An insert that is positioned in the lid is configured to be pierced by the spray nozzle of the brewing machine. The bottom is configured to be pierced by a discharge nozzle of the brewing machine, such that a hot drink is provided to a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a personalizable single-use brewing pod according to an embodiment of the disclosure.

FIG. 2 is a bottom view of an embodiment of the disclosure.

FIG. 3 is a side exploded view of an embodiment of the disclosure.

FIG. 4 is an exploded view of an embodiment of the disclosure.

FIG. 5 is a cross-sectional view of an embodiment of the disclosure.

FIG. 6 is a cross-sectional view of an embodiment of the disclosure.

### DETAILED DESCRIPTION OF THE INVENTION

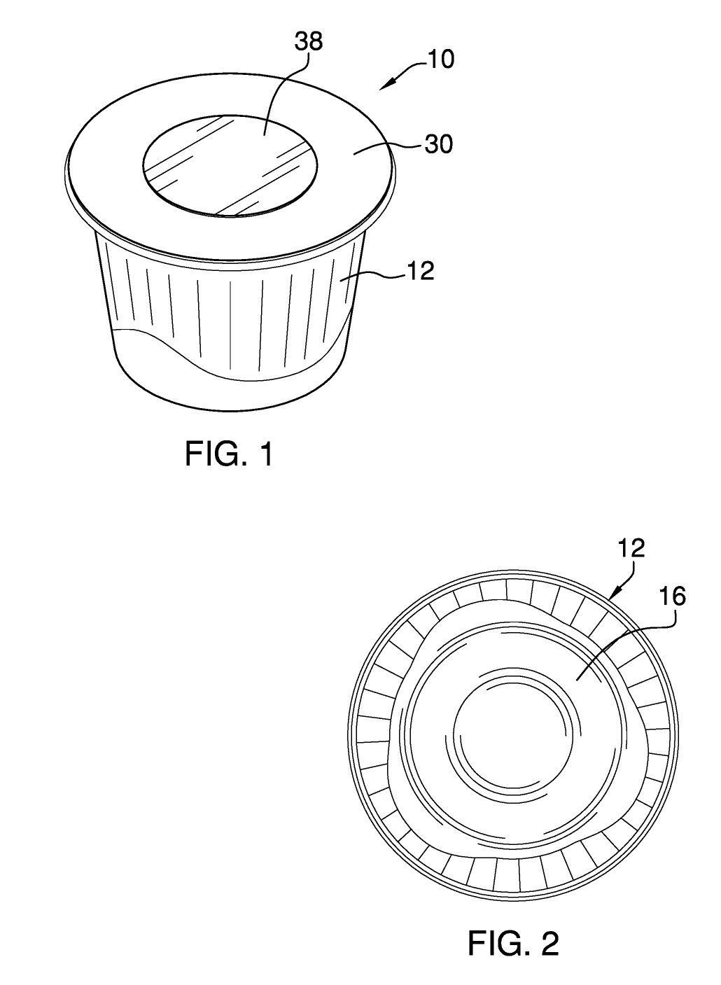

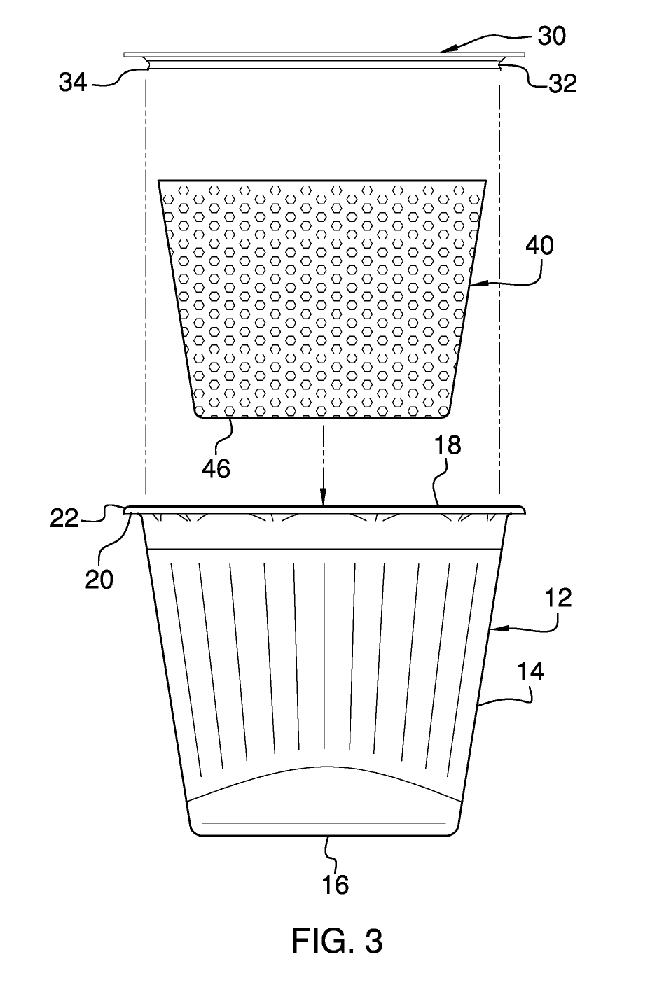

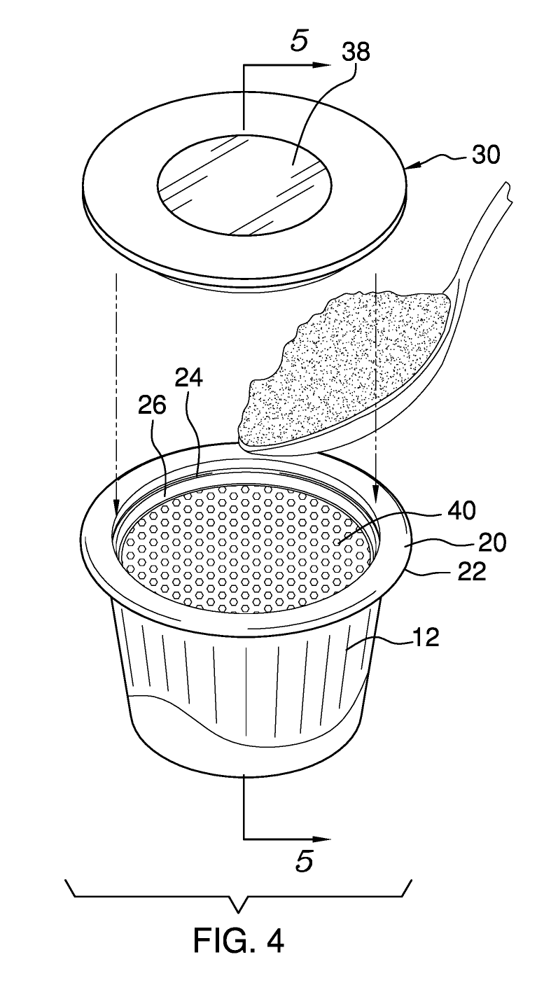

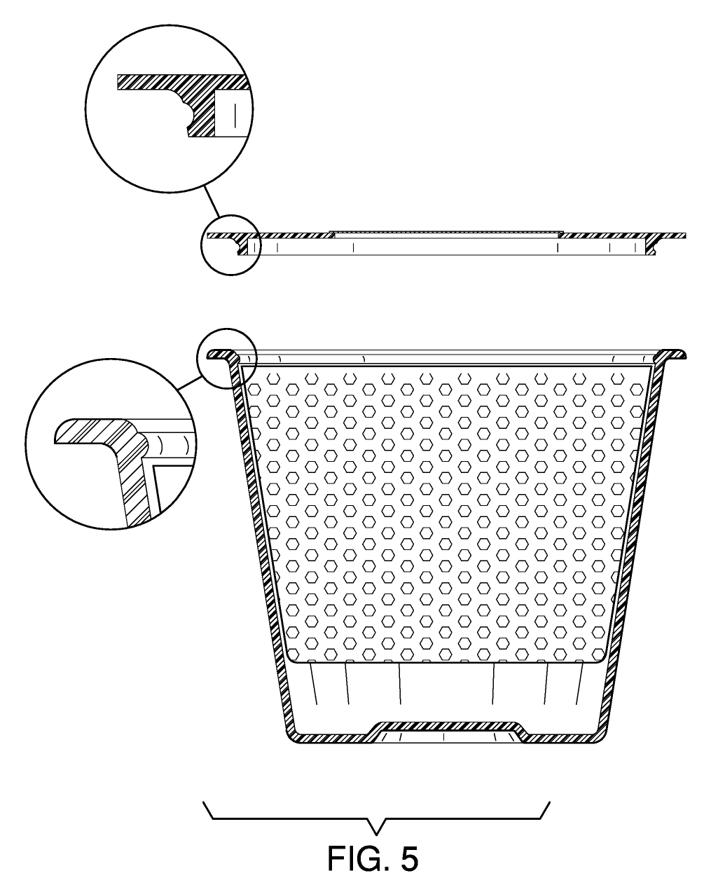

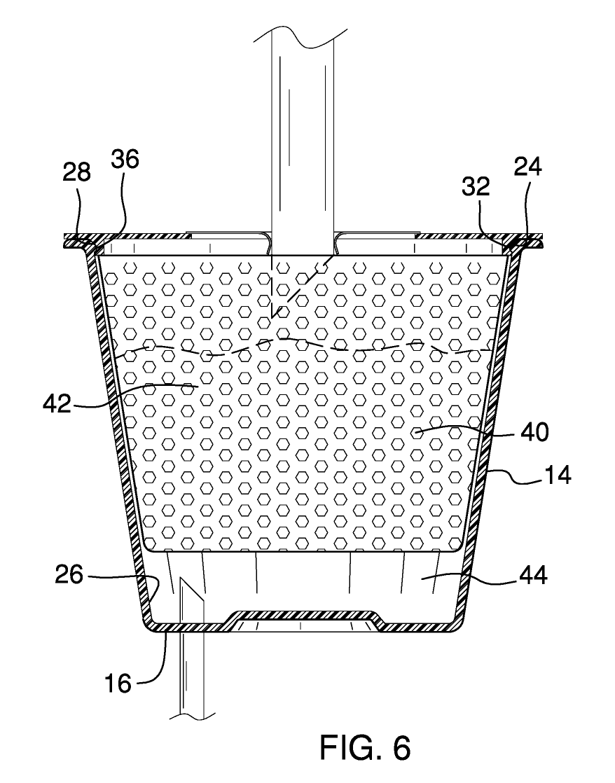

With reference now to the drawings, and in particular to FIGS. 1 through 6 thereof, a new brewing pod embodying the principles and concepts of an embodiment of the disclosure and generally designated by the reference numeral 10 will be described.

As best illustrated in FIGS. 1 through 6, the personalizable single-use brewing pod 10 generally comprises a cup 12 that has an annular wall 14 that extends upwardly from a bottom 16 to define an open top 18. The bottom 16 is configured to be pierced by a discharge nozzle of a brewing machine. In one embodiment, the bottom 16 and the open top 18 are circular. In another embodiment, the open top 18 is dimensionally larger than the bottom 16 such that the cup 12 is tapered. In yet another embodiment, the cup 12 comprises biodegradable plastic.

A lip 20 is coupled to the cup 12 adjacent to the open top 18. The lip 20 extends radially from the cup 12. The lip 20 and the open top 18 are substantially coplanar. The lip 20 has a perimeter 22. In one embodiment, the perimeter 22 is arcuate.

A first fastener 24 is coupled to an interior 26 of the annular wall 14 adjacent to the open top 18. In one embodiment, the first fastener 24 comprises an annular protrusion 28 that extends inwardly from the interior 26 of the annular wall 14. In another embodiment, the annular protrusion 28 is arcuate.

The brewing pod 10 comprises a lid 30 that is complementary to the open top 18. The lid 30 is sealably couplable to the cup 12. In one embodiment, the lid 30 comprises biodegradable plastic.

A second fastener 32 is coupled to a circumference 34 of the lid 30. The second fastener 32 is complementary to the first fastener 24. The second fastener 32 is positioned on the lid 30 such that the second fastener 32 is positioned to couple to the first fastener 24 to sealably couple the lid 30 to the cup 12. In one embodiment, the second fastener 32 comprises an annular grove 36.

An insert 38 is positioned in the lid 30. The insert 38 is configured to be pierced by a spray nozzle of the brewing machine. In one embodiment, the insert 38 comprises aluminum. In another embodiment, the insert 38 is substantially circularly shaped. In yet another embodiment, the insert 38 is substantially centrally positioned in the lid 30.

A filter 40 is positioned in the cup 12 and defines a brewing chamber 42 and a collection chamber 44. The filter 40 is frictionally couplable to the interior 26 of the annular wall 14. The filter 40 is positionable in the cup 12 such that a lower end 46 of the filter 40 is separated from the bottom 16 of the cup 12. The lower end 46 of the filter 40 and the bottom 16 of the cup 12 define the collection chamber 44. The lower end 46 of the filter 40 is positioned in the cup 12 such that the discharge nozzle of the brewing machine is positionable through the bottom 16 of the cup 12 into the collection chamber 44 without penetrating the lower end 46 of the filter 40.

In use, the filter 40 is positioned in the cup 12 such that the filter 40 is configured to add contents, including extractable solids such as coffee grounds and tea, and dissolvable solids, such as chocolate, into the brewing chamber 42. The lid 30 is configured to sealably couple to the cup 12 such that the contents are preserved in a fresh state. The cup 12, with the lid 30 coupled thereto, is configured to position in the brewing machine. The insert 38 is configured to be pierced by the spray nozzle of the brewing machine, and the bottom 16 is configured to be pierced by a discharge nozzle of the brewing machine, such that a hot drink is provided to a user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personalizable single-use brewing pod comprising:
a cup having an annular wall extending upwardly from a bottom defining an open top, said bottom being configured for piercing by a discharge nozzle of a brewing machine;
a lid complementary to said open top, said lid being sealably couplable to said cup;
an insert positioned in said lid, said insert being configured for piercing by a spray nozzle of the brewing machine;
a filter positioned in said cup defining a brewing chamber and a collection chamber; and
wherein said filter is positioned in said cup such that said filter is configured for addition of contents, including extractable solids such as coffee grounds and tea, and dissolvable solids, such as chocolate, into said brewing chamber, wherein said lid is configured to sealably couple to said cup such that the contents are preserved in a fresh state, wherein said cup with said lid coupled thereto is configured for positioning in the brewing machine, such that said insert is configured for piercing by the spray nozzle of the brewing machine and said bottom is configured for piercing by a discharge nozzle of a brewing machine into said collection chamber, wherein a hot drink is provided to a user.

2. The brewing pod of claim 1, further including said bottom and said open top being circular.

3. The brewing pod of claim 2, further including said open top being dimensionally larger than said bottom such that said cup is tapered.

4. The brewing pod of claim 1, further including said cup and said lid comprising biodegradable plastic.

5. The brewing pod of claim 1, further including a lip coupled to said cup adjacent to said open top, said lip extending radially from said cup, said lip and said open top being substantially coplanar.

6. The brewing pod of claim 5, further including said lip having a perimeter, said perimeter being arcuate.

7. The brewing pod of claim 1, further comprising:
a first fastener coupled to an interior of said annular wall adjacent to said open top;
a second fastener coupled to a circumference of said lid, said second fastener being complementary to said first fastener; and
wherein said second fastener is positioned on said lid such that said second fastener is positioned to couple to said first fastener to sealably couple said lid to said cup.

8. The brewing pod of claim 7, further comprising:
said first fastener comprising an annular protrusion extending inwardly from said interior of said annular wall; and
said second fastener comprising an annular grove.

9. The brewing pod of claim 8, further including said annular protrusion being arcuate.

10. The brewing pod of claim 1, further including said insert comprising aluminum.

11. The brewing pod of claim 1, further including said insert being substantially circularly shaped.

12. The brewing pod of claim 11, further including said insert being substantially centrally positioned in said lid.

13. The brewing pod of claim 1, further including said filter being frictionally couplable to an interior of said annular wall, wherein said filter is positionable in said cup such that a lower end of said filter is separated from said bottom of said cup, said lower end of said filter and said bottom of said cup defining said collection chamber, wherein said lower end of said filter is positioned in said cup such that the discharge nozzle of a brewing machine is positionable through said bottom of said cup into said collection chamber without penetrating said lower end of said filter.

14. A personalizable single-use brewing pod comprising:
a cup having an annular wall extending upwardly from a bottom defining an open top, said bottom being configured for piercing by a discharge nozzle of a brewing machine, said bottom and said open top being circular, said open top being dimensionally larger than said bottom such that said cup is tapered, said cup comprising biodegradable plastic;
a lip coupled to said cup adjacent to said open top, said lip extending radially from said cup, said lip and said open top being substantially coplanar, said lip having a perimeter, said perimeter being arcuate;
a first fastener coupled to an interior of said annular wall adjacent to said open top, said first fastener comprising an annular protrusion extending inwardly from said interior of said annular wall, said annular protrusion being arcuate;
a lid complementary to said open top, said lid being sealably couplable to said cup, said lid comprising biodegradable plastic;
a second fastener coupled to a circumference of said lid, said second fastener being complementary to said first fastener, wherein said second fastener is positioned on said lid such that said second fastener is positioned to couple to said first fastener to sealably couple said lid to said cup, said second fastener comprising an annular grove;
an insert positioned in said lid, said insert being configured for piercing by a spray nozzle of the brewing machine, said insert comprising aluminum, said insert being substantially circularly shaped, said insert being substantially centrally positioned in said lid;
a filter positioned in said cup defining a brewing chamber and a collection chamber, said filter being frictionally couplable to said interior of said annular wall, wherein said filter is positionable in said cup such that a lower end of said filter is separated from said bottom of said cup, said lower end of said filter and said bottom of said cup defining said collection chamber, wherein said lower end of said filter is positioned in said cup such that the discharge nozzle of a brewing machine is positionable through said bottom of said cup into said collection chamber without penetrating said lower end of said filter; and
wherein said filter is positioned in said cup such that said filter is configured for addition of contents, including extractable solids such as coffee grounds and tea, and dissolvable solids, such as chocolate, into said brewing chamber, wherein said lid is configured to sealably couple to said cup such that the contents are preserved in a fresh state, wherein said cup with said lid coupled thereto is configured for positioning in the brewing machine, such that said insert is configured for piercing by the spray nozzle of the brewing machine and said bottom is configured for piercing by a discharge nozzle of a brewing machine into said collection chamber, wherein a hot drink is provided to a user.
